(19) United States
(12) Patent Application Publication
(10) Pub. No.: US 2007/0174135 A1
(43) Pub. Date: Jul. 26, 2007

(54) METHOD AND SYSTEM FOR PROMOTING BIDS ON SELLER'S RELATED ITEMS

(75) Inventor: Gerard Alan Lynch, Newbury Park, CA (US)

Correspondence Address: DECHERT LLP, P.O. BOX 10004, PALO ALTO, CA, 94303, US

(73) Assignee: AuctionHelper.com, Newbury Park, CA (US)

(21) Appl. No.: 11/567,191

(22) Filed: Dec. 5, 2006

Related U.S. Application Data
(63) Continuation of application No. 10/302,740, filed on Nov. 22, 2002, now abandoned.

(51) Int. Cl. G06Q 30/00

(52) U.S. Cl. 705/26

(57) ABSTRACT

A method for showing potential bidders of online auctions specific items currently at auction for a given seller by embedding a display window object inside item pages of items posted for auction by the same seller, where the display window object includes a rotating group of images and means for acquiring the images. By querying a remote database for the least trafficked, most trafficked, or seller-specific content of a given seller, the display window object uses the query results to show a pre-defined number of other items currently posted for auction by a seller, inside any item currently posted for auction by that same seller.

### CROSS REFERENCE TO RELATED APPLICATION

This application is a continuation of U.S. patent application Ser. No. 10/302,740, titled “METHOD AND SYSTEM FOR PROMOTING BIDS ON SELLER'S RELATED ITEMS,” filed Nov. 22, 2002.

### FIELD OF THE INVENTION

The present invention relates generally to on-line auctions and more particularly to the promotion of a seller's other auction items that are related to the seller's current auction item.

### DESCRIPTION OF THE RELATED ART

Sellers selling items on online auctions will very often times have more of certain items viewed by potential bidders than other items being auctioned at the same time. Sellers with large amounts of items running at the same time often realize a much smaller number of views per auction than sellers who list small amounts of items.

The primary reason for an item not being viewed by many potential bidders is that when the bidder conducts a search on the auction site, too many items are returned in the search results and a particular item gets lost in the mix. Additionally, many times a seller running large groups of auctions will have disproportioned page views. Some items may be seen more times than others due to the overall population of like items found throughout the auction site. The above is indicative of a bigger problem with current auction sites, which is that a seller has too little control over which, among a plurality of the seller's items, a potential bidder views when accessing the auction site. It would be highly desirable for the seller to influence or control which of the seller's related items the potential bidder sees when viewing an item page from the auction site.

### BRIEF SUMMARY OF THE INVENTION

The present invention is directed towards the ability of the seller to control which among a plurality of seller's items posted for auction, a potential bidder sees. Because many of a given seller's items may get lost in the mix of other like items being sold by other sellers, a solution is needed to show potential bidders more of the seller's items that are being viewed the least. Conversely, some sellers may want to show potential bidders which items are being viewed the most, believing that it may increase the final bid price even higher if more people are interested in a given product. The seller may also want to pre-define specific items to show potential bidders based on their own configuration of like-items, current bid, total quantity available, or other metric to cross-promote specific items currently at auction by a given seller based on dynamic metrics at the time the viewer is viewing the auction item, because it is believed that the more items a seller shows to a potential bidder, the greater the chances of that item being bid on and/or sold.

The present invention provides users with a simple user-interface that allows sellers to dynamically promote other current running items from within the item auction description, or from any other web pages.

One method in accordance with the present invention includes a computerized method of promoting bids for any items related to an item posted for auction. The method includes selecting, at an auction site, the item posted for auction by a seller and receiving for display an item page for the item from an auction site, where the item page has embedded therein a banner window object. A unique name identifying the seller of the item and an ID for the item are transmitted to a remote database which includes a hit counter for each seller item stored therein. The hit counter is incremented for the item identified by the ID and the remote database retrieves information records of any seller-related items posted for auction based on the unique name and the hit counters for any related items, where the information records including pictures of any related items which are specified for display in the banner window of the banner window object. The information records from the remote database are then received by the user.

One advantage of the present invention is that sellers can control in real time, the viewing of items related to a particular item posted for bid by the seller. This control can be based on how often the other items have been viewed, making the control dynamic.

Another advantage is that sellers can more easily promote other items a potential bidder may be interested in bidding on and likely as a result receive more bids.

### BRIEF DESCRIPTION OF THE DRAWINGS

These and other features, aspects and advantages of the present invention will become better understood with regard to the following description, appended claims, and accompanying drawings where:

FIG. 1 shows a system setting in which the present invention operates;

FIG. 2A shows a representative browser item page;

FIG. 2B shows a representative browser page with an embedded display window in accordance with the present invention; and

FIG. 3 shows the two phases of the embedded display window; and

FIG. 4 shows a flow chart in accordance with an embodiment of the present invention.

### DETAILED DESCRIPTION OF THE INVENTION

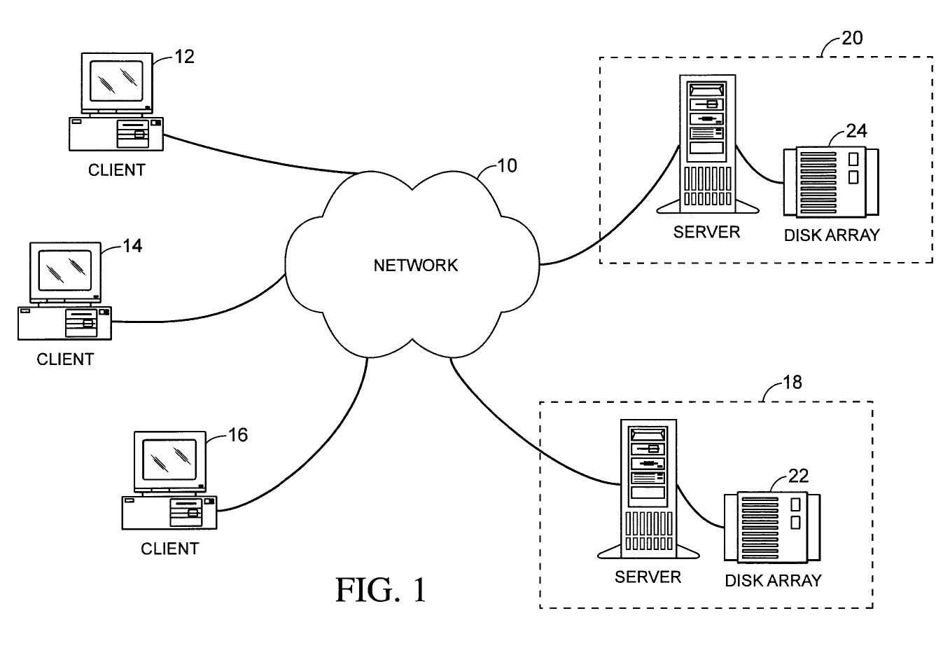

FIG. 1 shows a system setting in which the present invention operates. A network 10, such as the Internet, connects a plurality of computer systems, including one or more client computer systems 12, 14, 16, and one or more server computer systems 18, 20, as shown. A client computer system 12, 14, 16 is typically a personal computer system having a browser capable of viewing HTML documents. A server computer system 18, 20 is typically a computer system having a large disk array 22, 24 which holds a database with many HTML documents and programs for searching and delivering those documents to the client computer systems 12, 14, 16 over the network 10 in response to requests from the client computer systems 12, 14, 16.

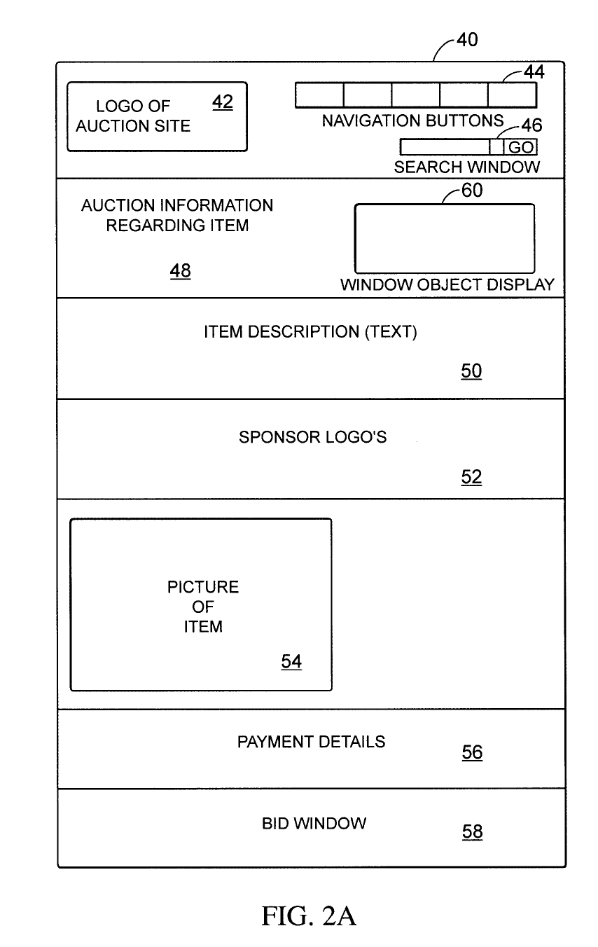

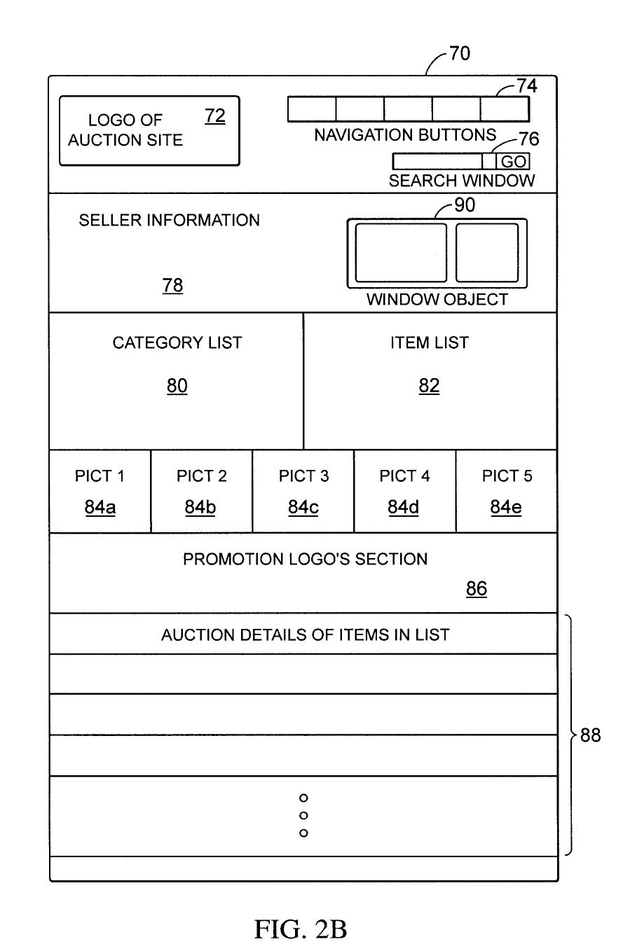

FIG. 2A shows a representative browser item page 40, which typically includes a logo of the auction site, navigation buttons 44, a search window with an activation button 46, an area 48 for displaying auction item information, an area for item description text 50, an area for sponsor logos 52, a picture of the item 54, payment information 56 and a bid information area 58. The embedded display window 60 may be placed in any suitable location within the page.

FIG. 2B shows a representative browser page with an embedded display window in accordance with one embodiment of the present invention. This browser page 70 includes a logo for the auction site 72, a set of navigation buttons 74, a search window with an activation button 76, an area for displaying information about the seller 78, a list of categories of items available from the seller 80, a list 82 of the items posted for auction within a selected category, an area 84 for displaying pictures 84a-e of the items in the item list, an area for displaying promotion information 86, and a set of areas 88 for showing the details of each item in the item list 82. The embedded display window 90 may be placed in any suitable place within the page 70.

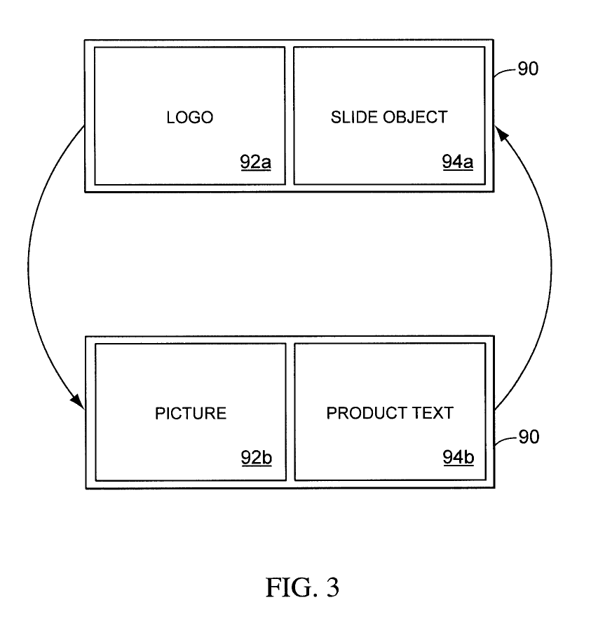

FIG. 3 shows the two phases of the embedded display window 90 of FIG. 2B. The embedded display window has two sides. In a first display phase, the shutter 94a, possibly with some overlay text, is displayed on one side of the display window and a company logo 92a or similar graphic is displayed on the other side. In a second display phase, the shutter is removed revealing text information 94b descriptive of a product whose picture 92b is displayed on the side on which the company logo was displayed. Of course other arrangements are possible and in keeping with the present invention.

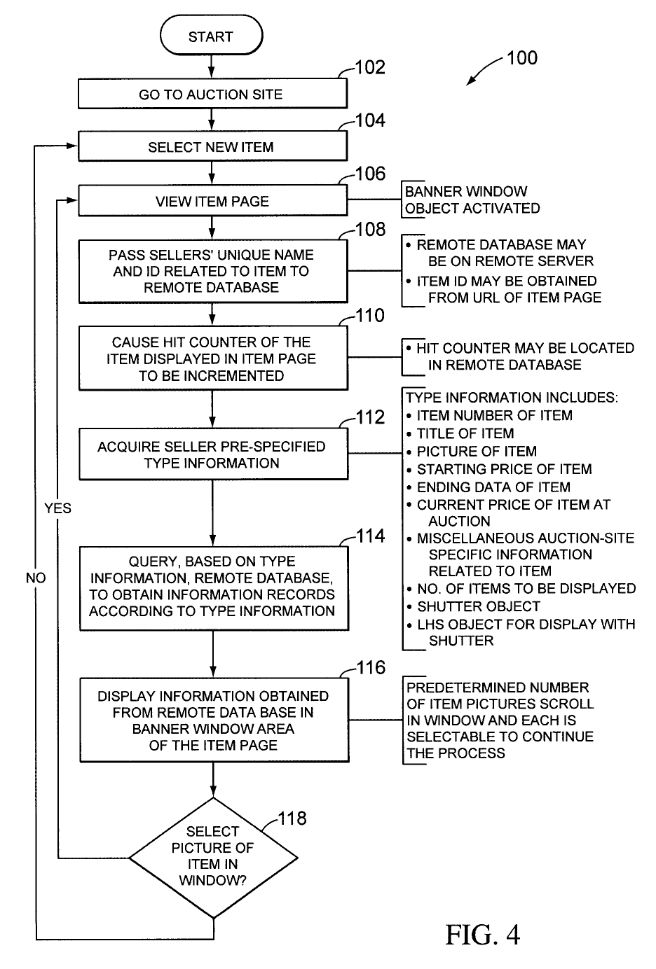

FIG. 4 shows a flow chart 100 in accordance with an embodiment of the present invention. The process starts in step 102 by a user visiting a network site at which on-line auctions are conducted, i.e., an auction site and selecting a new item, in step 104. The user then either receives and views, in step 106, an item page such as that shown in FIG. 2A or a seller specific item page such as that shown in FIG. 2B. If the received page includes a banner window object of the present invention, the viewing of the item page causes, in step 108, a unique name of the seller of the item and an ID related to the item to be sent to a remote database, preferably on a separate remote server. The remote database may also reside on the auction site server. The item ID is preferably and most easily obtained from the URL of the item page being viewed. At about the same time as this information is sent to the remote database, a hit count of the item displayed is incremented in step 110. The hit counter resides in the remote database and the remote database is instructed by the banner window object to increment the hit counter and to return the current count to the banner window object. The hit counter indicates how many times that item has been viewed by a potential bidder. By accumulating this information, a list can be formulated of the least- or most-viewed items, and/or specific configurations (of what to search for that is predefined by the seller), for other items currently at auction by same seller. In one embodiment, a seller of the item pre-configures settings as to the type of items that are to be shown to viewers observing their items having the embedded banner window object. The remote database, using the received seller unique name and ID of the item, then acquires, in step 112, seller pre-specified type information. In one embodiment, the type information is returned to the user's browser. In another embodiment, the type information is returned to the remote server on which the remote database is installed.

This type information is set forth in the table below.

The Item Number of the item
The Title of the item
The picture of the item
The starting price of the item
The ending price of the item
The current price of the item at auction
Miscellaneous Auction site-specific
attributes related to the item at auction.
The number of items to be displayed
The shutter for the window
The default logo when shutter is displayed

The pre-specified type information includes, among other things, the number of items to be displayed, and possibly a shutter (a picture object) for the window and a default logo (a picture object) for display with the shutter. Furthermore, the pre-specified type information may depend on the seller unique name only or on the seller unique name and the item ID. The latter permits item-specific tailoring of information for a seller.

Another query is then made, in step 114, on the same remote database to obtain displayable information in accordance with the seller's pre-specified type information. Depending on the above embodiments, this query is either made by the user's browser or by the remote server but in either case, the requested information is returned, in step 116, to the user's browser. The number of pictures specified in the type information is made available for viewing in the banner object window. In one version the pictures are scrolled in the window, and the scrolling speed is controllable by the positioning of a cursor in the display area. Each picture is selectable as an item, thereby restarting the process.

As an example, suppose a seller has 500 items currently posted for auction and the seller wants to display in an item page 30 items that have not been viewed at least 5 times (or any amount predetermined by the seller). These 30 items are obtained through the above process and shown inside a banner window object display window in the user's browser. Once “on screen,” this list of 30 items is rotated, one after the other, every 5 seconds (or a predetermined amount of time), such that the person viewing the auction can select (by clicking on) one of the items shown and be taken to the item page for that item. Every time an item page from the auction site is viewed, the viewing creates a possible change of the outcome of another query because the hit counter is changed, which potentially can change the 30 items that have not been view at least 5 times. The banner window object may be an object (such as a Flash object) that is embedded in the HTML code of the online auction item page.

As mentioned above, a company logo, in one embodiment, may be made available for display in the banner window object display area. The banner window object controls the actions of the company logo. In the embodiment, the company logo appears and text on the shutter requests that the user view the company's most popular items that are currently up for auction. Then, for each item having a picture, the picture appears on one side and the title and picture description appears in on the other side. Upon clicking on one of those items, users are taken directly to that item on the auction site and the process is available to be repeated.

As another alternative, a company logo or other special slide may indicate that the seller's most popular items may be accessed by clicking the logo or other special slide. Upon clicking on the logo, the user is taken to an extended gallery page of that seller's items. Upon clicking on the special slide, the user is taken to a list of items available from the seller but in a particular category. For example, when a such “group” slide, say a slide for “power tools,” is used, the user is taken to a list of all power tools at auction for that seller.

The company logo can reside anywhere inside of the item page or on the auction “about me” page or on any other Web page, anywhere. A company logo object can include dynamic information such as live data from statistics generated according to user-changeable categories and obtained by means of the auction site's API.

This embedded banner window object of the present invention solves the problem that buyers who access auction sites are not always given the most up-to-date information. Online auctions typically have a 3, 5, 7 or 10 day duration. In accordance with the present invention, once an auction is launched, a seller can update buyers and better promote other of the seller's currently posted items. Markets sometimes change and current events cause values to rise and fall. The embedded banner window object of the present invention allows a seller to communicate and promote, in real time, its business/other items for sale in a quick and efficient format.

Although the present invention has been described in considerable detail with reference to certain preferred versions thereof, other versions are possible. For example, instead of displaying seller related items based upon the viewing of a seller's item, the method of the present invention also contemplates displaying seller related items based on the type of item on which a bid was currently received by the user. In this version, the remote or auxiliary database maintains information on items for which a bid has been received including the time at which the bid was received and the seller pre-defines items related to the type of item for which a bid was currently received. As an example, suppose that a seller's electric drill item just received a bid, then other electric items of the seller found in the same category can be shown after receiving the bid. These other items can include items of the seller that have not received a bid, or have not received a bid within a predetermined time interval, or items randomly selected from the seller's list of items posted for auction. Also, the other items shown can be comparable in price to the price bid on the item. Therefore, the spirit and scope of the appended claims should not be limited to the description of the preferred versions contained herein.

What is claimed is:

1. A computerized method of promoting bids for any items related to an item posted for auction, comprising:
selecting, at an auction site, the item posted for auction by a seller;
receiving for display an item page for the item from an auction site, the item page having embedded therein a banner window object;
transmitting to a remote database a unique name identifying the seller of the item and an ID for the item, the remote database including a hit counter for each seller item stored therein;
causing the hit counter for the item identified by the ID to be incremented;
causing the remote database to retrieve information records of any seller-related items posted for auction based on the unique name and the hit counters for any related items, the information records including pictures of any related items, said pictures being specified for display in the banner window of the banner window object; and
receiving information records from the remote database.

2. A computerized method of promoting bid as recited in claim 1, wherein the step of causing the remote database to retrieve information records includes:
obtaining from the remote database, in response to the unique name and item ID, seller pre-specified type information, the type information specifying the type of information available for display relating to an item, including whether a picture is available for an item; and
querying to the remote database to obtain information records, based on the unique name and item ID, in accordance with the type information.

3. A computerized method of promoting bids as recited in claim 1, wherein the type information specifies a title for an item.

4. A computerized method of promoting bids as recited in claim 1, wherein the type information specifies a starting price for an item.

5. A computerized method of promoting bids as recited in claim 1, wherein the type information specifies an ending price for an item.

6. A computerized method of promoting bids as recited in claim 1, wherein the type information specifies a current price for an item.

7. A computerized method of promoting bids as recited in claim 1, wherein the type information specifies how many items to be displayed.

8. A computerized method of promoting bids as recited in claim 1, wherein the type information specifies a shutter for the window.

9. A computerized method of promoting bids as recited in claim 1, wherein the type information specifies a default logo for display with a shutter.

10. A computerized method of promoting bids as recited in claim 1, wherein the pictures scroll in the banner window.

11. A computerized method of promoting bids as recited in claim 1, wherein any picture displayed in the banner window is selectable to cause the receipt of the item page for the selected item from the auction site.

12. A computerized method of promoting bids as recited in claim 1, wherein the transmitting step is performed by the banner window object.

13. A computerized method of promoting bids as recited in claim 1, wherein the embedded banner window object includes a procedure for updating a hit counter in a remote database for the item whose page is received.
